(19) United States
(12) Patent Application Publication
(10) Pub. No.: US 2021/0295079 A1
(43) Pub. Date: Sep. 23, 2021

(54) SOURCE IDENTIFICATION OF PRINTED MEDIA

(71) Applicant: Hewlett-Packard Development Company, L.P., Spring, TX (US)

(72) Inventors: Justin Miller, Boise, ID (US); Brett Hunt, Boise, ID (US); Kristofer Metz, Boise, ID (US)

(73) Assignee: Hewlett-Packard Development Company, L.P., Spring, TX (US)

(21) Appl. No.: 17/258,796

(22) PCT Filed: Dec. 12, 2018
(86) PCT No.: PCT/US2018/065204

§ 371 Date: Jan. 8, 2021

(51) Int. Cl. G06K 9/20; G06K 9/00; H04N 1/32

(52) U.S. Cl. CPC G06K 9/2081; H04N 1/32352; G06K 9/2063; G06K 9/00577

(57) ABSTRACT

Some examples include a mobile computing device including imaging hardware to capture an image of a printed media, memory to store instructions, and a processor. The processor is to execute the instructions to detect the printed media within a field of view of the imaging hardware, dynamically guide a user to position the field of view to capture a region of the printed media including an embedded print pattern, detect the embedded print pattern within the region, correlate the embedded print pattern with a source identification of the printed media, and determine the source identification of the printed media.

### BACKGROUND

Embedded print patterns, such as digital watermarks and other visual codes or marks, can be added to or embedded into images that are printed on physical media like paper, cardboard, and labels to provide information about the printed document. An embedded print pattern may or may not be visible or perceptible to the naked eye, but even if visible or perceptible, is not intuitively understandable to a human viewer. An embedded print pattern that is not visible or perceptible to the naked eye includes codes that are created by imperceptibly changing low-level aspects of the image in a way that a human viewer will not be able to perceive. The embedded print pattern can be a pattern of dots that is not noticeable to the naked eye that contains information that is not understandable by a human viewer.

### BRIEF DESCRIPTION OF THE DRAWINGS

FIG. 1 is a block diagram of an example mobile computing device in accordance with aspects of the present disclosure.

FIG. 2 is a block diagram of an example imaging hardware useful in the mobile computing device of FIG. 1 in accordance with aspects of the present disclosure.

FIG. 3 is a block diagram of an example non-transitory computer readable medium comprising a set of instructions executable by a processor in accordance with aspects of the present disclosure.

FIGS. 4A and 4B are schematic illustrations of example printed media including an embedded print pattern in accordance with aspects of the present disclosure.

FIG. 5 is a flow diagram of an example method of determining a source identification of a printed media.

FIG. 6 is a flow diagram of an example method of determining a source identification of a printed media.

FIGS. 7A-7C illustrate an example of dynamic guiding useful in captured images of a printed media in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

As noted in the background section, embedded print patterns can be patterns or other marks that can be added to or embedded into images that are printed on physical media. The embedded print patterns can be covert and imperceptible to the naked eye. Users can employ mobile computing devices that include digital image-capturing hardware, such as smartphones that include digital cameras, to capture images of the physical media on which the embedded print pattern-containing images have been printed. Image processing can then be performed on the captured images at the mobile computing devices, or at another computing device like a server to which the mobile computing devices have uploaded their captured images, to detect the embedded print patterns within the captured images. Once an embedded print pattern has been identified within an image captured by a mobile computing device, a translation of the embedded print pattern can be used to identify information about the printed media based on the information contained in the embedded print pattern.

As an example, a user may be viewing a printed document that includes a unique embedded print pattern. The user may be interested in learning more about the printed document. The user can capture an image of the printed document via his or her smartphone. The smartphone can perform image processing to detect and decode the embedded print pattern, which may provide metadata regarding the source of the printed document. In one example, the printed document is “fingerprinted” with a unique embedding print pattern that can be matched with metadata related to one or more features specifically associated to the printed document. Metadata is a set of data that describes and gives information about other data. Metadata can provide information about one or more aspects of the data and can be used to summarize information about data that can make tracking the print source of a document easier. Metadata can include the means of creation of the data, the time and date of creation, the creator or author of the data, a location on a computer network where the data was created, source of the data, and the process used to create the data, how long the document is, a short summary of the document, the printer used to print the document, and the user initiating the printing of the document, for example. Imaging processing detects and decodes the embedded print pattern within the image, which may provide metadata correlating to the print system used to print the document.

Techniques for utilizing an embedded print pattern printed on a physical medium hinge on the ability to detect and decode the embedded print pattern within a captured image of the physical medium. If the embedded print pattern cannot be detected and read within a captured image, then no action corresponding to the information contained with embedded print pattern can be performed. However, detecting and reading embedded print patterns within images captured by mobile computing devices, like smartphones, may be difficult in certain circumstances, such as when the view of the printed media is obstructed or the distance of the mobile computing device from the printed media is not appropriate to accurately read the embedded print pattern.

It can be useful to direct the user to position the mobile computing device to an appropriate distance and orientation to the printed media in order to improve the detection and readability of the embedded print pattern. For example, image capturing conditions, such as the distance or angle between the image-capturing hardware and the embedded print pattern can affect the ability of image processing to detect and read the embedded print pattern within an image captured under such conditions. The print quality and embedded print pattern detectability parameters of the printing can also affect the ability of image processing of the mobile computing device to detect and read the embedded print pattern within an image.

Furthermore, smartphones can have advanced image-capturing hardware and image-capturing capabilities that can capture images in which embedded print patterns are less likely to be detected. For example, the image-capturing hardware may be more advanced in that the hardware can capture images that are more pleasing to the human eye but from which embedded print patterns are less easily detectable. As another example, the image-capturing hardware may automatically perform advanced image processing to remove artifacts from captured images, but which also removes certain details on which basis embedded print patterns may be detected. Therefore, there is no guarantee that newer mobile computing devices will improve embedded print pattern detection and readability from their captured images, because generally the goal of improving image-capturing hardware of mobile devices like smartphones is not to aid in embedded print pattern detection.

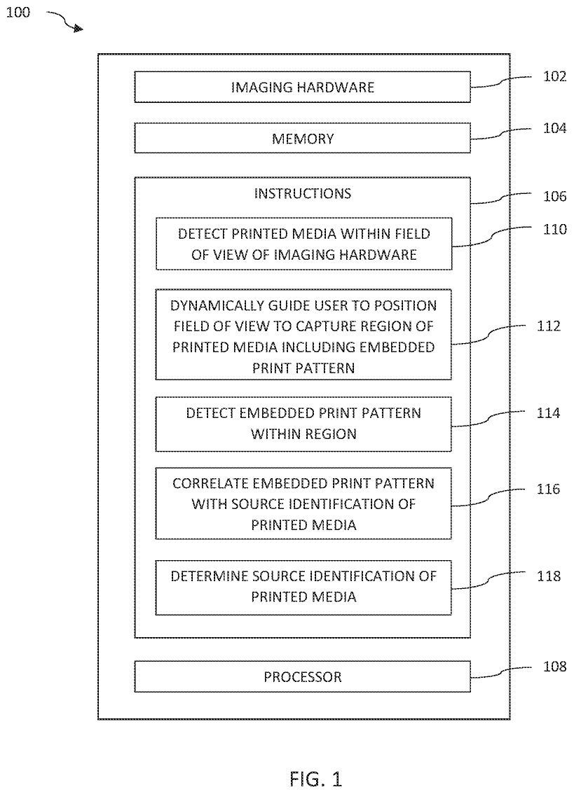

FIG. 1 is a block diagram of an example mobile computing device 100 in accordance with aspects of the present disclosure. Mobile computing device 100 can include an imaging hardware 102, a memory 104, and a processor 108. Imaging hardware 102 can capture an image of a printed media including an embedded print code. Memory 104 can store data, programs, instruction, or any other machine readable data that can be utilized to operate mobile computing device 100. Memory 104 can store computer executable instructions 106 such as may be fetched and/or executed by processor 108. Instructions 106 can include a set of instructions 110-118, for example. Instruction 110 can be to detect printed media within a field of view of the imaging hardware 102. Instruction 112 can be to dynamically guide a user to position the field of view to capture a region of the printed media including an embedded print pattern. Instruction 114 can be to detect the embedded print pattern within the region. Instruction 116 can be to correlate the embedded print pattern with a source identification of the printed media. Instruction 118 can be to determine the source identification of the printed media.

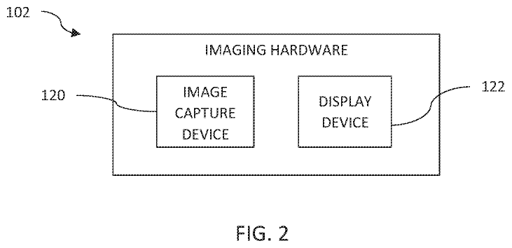

Mobile computing device 100 can be a cellular telephone, a personal digital assistant (PDA), or other smartphone-type device, as well as a portable or tablet computing device, for example. With additional reference to the example imaging hardware 102 illustrated in FIG. 2, imaging hardware 102 of mobile computing device 100 can include an image capture device 120, such as a digital camera, and a display device 122. Image capture device 120 can be an input device for electronically capturing photograph images or video images of objects or scenes positioned within a field of view (FOV) of the image capture device 120. Display device 122 of imaging hardware 102 can be an output device for presentation of information in visual form. Display device 122 can include a Thin Film Transistor (TFT) display, a Liquid Crystal Display (LCD) display, an Organic Light-Emitting Diode (OLED) display, an active-matrix organic light-emitting diode (AMOLED) display, a capacitive touchscreen display, a resistive touchscreen display, or a Thin Film Diode (TFD) display. Other suitable displays are also acceptable. Imaging hardware 102 can capture and/or display images on an on-going, continuous, or periodic basis.

With continued reference to FIG. 1, memory 104 of mobile computing device 100 can include any form of computer-readable memory. In one example, memory 104 is a non-transitory computer readable medium. In other examples, the memory such a semiconductor memory device, magnetic disk such as an internal hard disk and removable hard disk, magneto-optical disks, CD-ROM/RAM, DVD-ROM/RAM, flash ROM, non-volatile ROM/RAM, etc. Processor 108 can be a computing device and can include an application specific integrated circuit (ASIC), or a digital signal processor (DSP), among other features. In addition to memory 104 and processor 108, mobile computing device 100 can includes any associated hardware and/or machine readable instructions (including firmware and/or software), for implementing and/or executing computer-readable, computer-executable instructions for data processing functions and/or functionality.

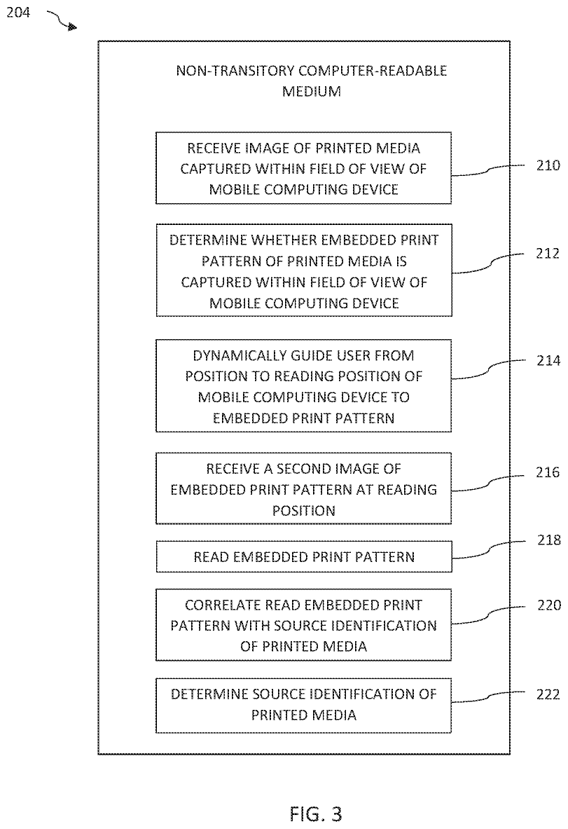

FIG. 3 is a block diagram of an example non-transitory computer readable data storage medium 204 comprising a set of instructions executable by a processor in accordance with aspects of the present disclosure. In one example, non-transitory computer-readable storage medium 204 is including in the memory of the mobile computing device and includes a set of instructions 210-222 executable by the processor. Instruction 210 is to receive an image of a printed media captured within a field of view of the mobile computing device. Instruction 212 is to determine whether an embedded print code of the printed media is captured within the field of view of the mobile computing device. Instruction 214 is to dynamically guide a user from a position to a reading position of the mobile computing device to the embedded print pattern. Instruction 216 is to receive a second image of the embedded print pattern at the reading position. Instruction 218 is to read the embedded print pattern. Instruction 220 is to correlate the read embedded print pattern with a source identification of the printed media. Instruction 222 is to determine the source identification of the printed media.

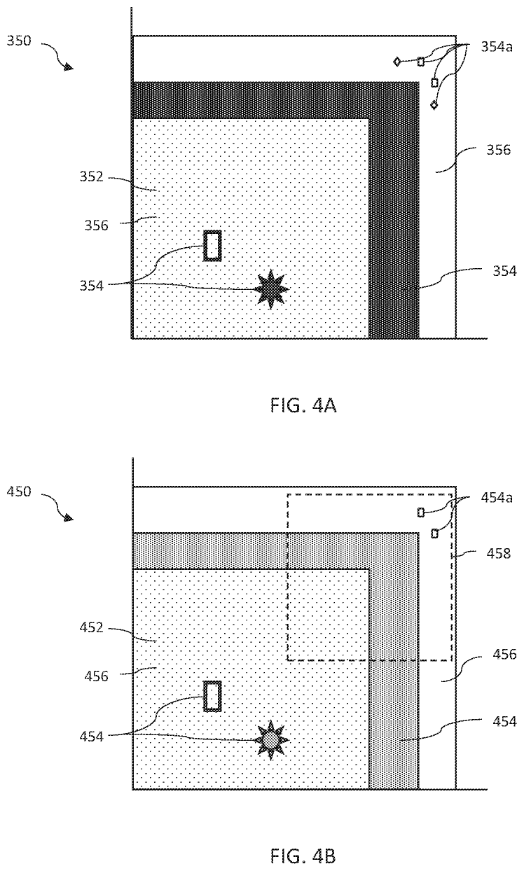

FIGS. 4A and 4B are schematic illustrations of example printed media 350, 450 including an embedded print pattern 352, 452 in accordance with aspects of the present disclosure. Printed media 350, 450 can include visible print content 354, 454 and embedded print pattern, or embedded print content, 352, 452. Visible print content 354, 454 can include any pictorial, graphical, or textural characters, symbols, illustrations, and/or other representations of information. Visible print content 354, 454 can substantially conceal embedded print pattern 352, 452 on print media 350, 450. Embedded print pattern 352, 452 is such that, under normal viewing conditions, embedded print pattern 352, 354 is not readily visible. For example, embedded print pattern 352, 452 can be printed with a low visibility marking material. In one example, the low visibility marking material includes yellow ink or toner. Thus, by substantially concealing visibility of embedded print pattern 352, 452, embedded print pattern 352,452 is not readily visible under normal viewing conditions. Under enhanced viewing conditions, however, as described further below, embedded print pattern 352, 452 is readily visible and identifiable. In addition, by substantially concealing visibility of embedded print pattern 352,452, embedded print pattern 352, 452 is not easily and/or accurately photocopied and/or modified. Embedded print pattern 352, 452 can include any pattern of nearly imperceptible or covert dots, for example, or any other pictorial, graphical, and/or textural characters, symbols or other representation of information. Embedded print pattern 352, 452 can be printed in one or more areas of printed media 350, 450.

Visible print content 354, 454 and embedded print pattern 352, 452 can be specifically tailored to the administrator's document criteria to address print quality and print security concerns or issues. The embedded print pattern 352, 452 can be specifically tailored to the administrator's document criteria to address print quality and print security concerns or issues. The administrator, such as Information technology (IT) personnel of an organization, may select from a number of different configurations to obtain desired print and security parameters including print quality and embedded print pattern detectability. In obtaining greater print quality, often the detectability of the embedded print pattern detectability lessened and vice versa. The desirable print quality and embedded print pattern detectability criteria is evaluated and selected by the IT personnel.

Print quality and print security of the printed media can be inversely corresponded. For example, with reference to FIG. 4A, print quality of visible print content 354 may be of greater importance to the administrator than print security, causing embedded print pattern 352 to be more difficult to detect and read through visible print content 354. With reference to FIG. 4B, in another example, print security of the printed media is of greater importance than print quality to the administrator and embedded print pattern 452 can be read and detected through visible print content 454 more easily with mobile computing device 100. In some examples, embedded print pattern 352, 452 can be included in a white space 356, 456, such as a border around a print area or interspersed amount the visible print content within the print area. In one example, embedded print pattern 352, 354 can include an additional embedded pattern 352a, 452a printed in a predetermined white space 356, 456 such as a corner of the border to be easily discernable from the visible print content 354, 454 to increase detectability and readability by mobile computing device 100.

Mobile computing device 100 can detect a presence or absence of embedded print pattern 352, 452. The detection of embedded print pattern 352, 452 can include selecting a region 358, 458 (e.g., less than the full page of printed media) from a whole print document (e.g., full sheet of medium). Embedded print pattern 352, 452 can be used to assist in guiding user to position mobile computing device 100 to a reading position. In one example, embedded print pattern 352a, 452a disposed in border area 356,456 can be used to direct or guide the user to orient mobile computing device toward region 358, 458 at the corner of printed media 350, 450. By viewing (i.e., imaging) printed media 350, 450 through imaging hardware 102 of mobile computing device 100, printed media 350, 450 can be automatically recognized and the unique embedded print pattern, or code, 352, 452 of printed media 350, 450 can be “highlighted” in the viewing.

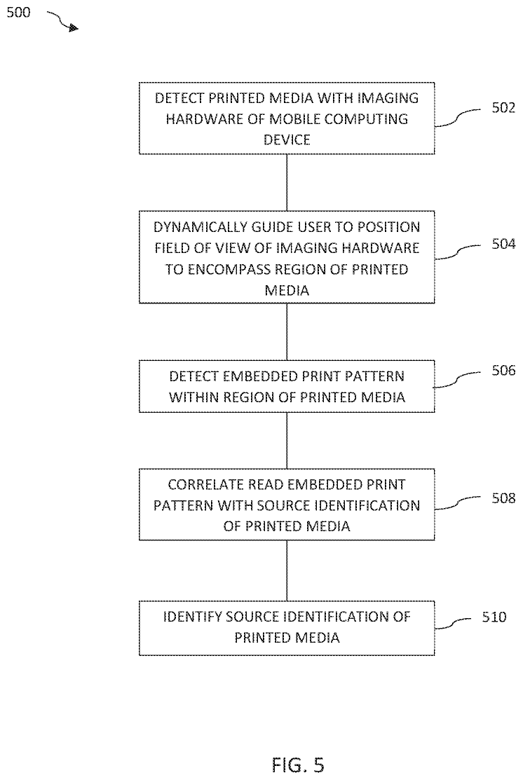

FIG. 5 is a flow diagram of a method of determining a source identification of a printed media. At 502, a printed media is detected with an imaging hardware of a mobile computing device. At 504, a user is dynamically guided to position a field of view of the imaging hardware to encompass a region of the printed media. At 506, an embedded print pattern is detected within the region of the printed media. At 508, the embedded print pattern is correlated with a source identification of the printed media. At 510, the source identification of the printed media is identified.

In one example, the steps are performed via computer-executable instructions, or instructions, can be communicated between mobile computing device and a computer server that may be located remotely and accessible, for example, over a network. Communication network can include a local-area network (LAN) and/or a wide-area network (WAN). Communication network, therefore, can include an intranet communication network, an Internet communication network or a similar high-speed communication network including a wireless communication network.

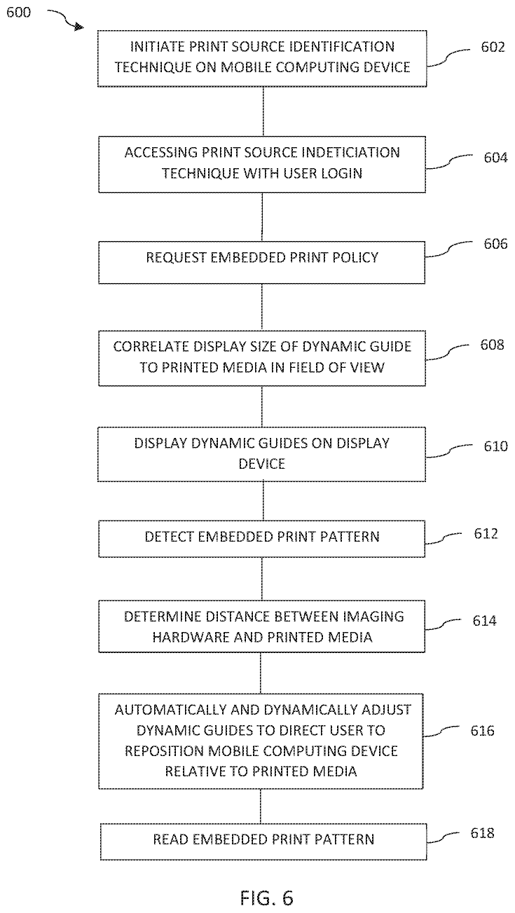

FIG. 6 is a flow diagram of another example method 600 of determining a source identification of a printed media. At 602, a print source identification technique is initiated on a mobile computing device, such as mobile computing device 100. At 604, the print source identification technique can be accessed with a user login information entered by the user into the mobile computing device for security and verification of the user. At 606, an embedded print policy implemented by the administrator, or organization, can be requested and/or communicated. The policy can include information on print quality, information on detectability of the embedded print content, and position of the embedded print content on the print media, for example. At 608, the technique determines and correlates a display size of a dynamic guide relative to the size of the printed media in the field of view of the image capture device of the imaging hardware. At 610, dynamic guides can be displayed on the display device of the imaging hardware. For example, a dynamic guide including two perpendicularly intersecting lines can be sized appropriately to correspond with the corner of the printed media positioned within the field of view. In other examples, messages, arrows, dots, or other dynamic guides are displayed. At 612, the embedded print pattern is detected. At 614, the distance between the imaging hardware and the printed media is determined.

At 616, the dynamic guides are automatically dynamically adjusted (e.g., size, position) to dynamically direct the user to reposition the mobile computing device and field of view relative to the printed media to position the printed media at an adjusted “reading” distance and position. The print source identification technique can determine distance and orientation between the printed media and the imaging hardware (e.g., the image capture device). The print source identification technique interactively directs the user via dynamically and automatically repositioning and resizing dynamic guides to reposition the mobile image capture device of the mobile computing device and/or the printed media relative to each other to adjust distance and/or orientation to improve readability of the embedded print media of the printed media. The user can reposition the mobile computing device and/or the printed document until the image capture device technique provides an indication that appropriate alignment and distance has been achieved and the mobile computing device is at a reading position. At 618, the embedded print pattern is read. The print source identification technique can detect and “read” the embedded print content in order to correlate the embedded print pattern with a source identification of the printed media in order to determine the source identification of the printed media.

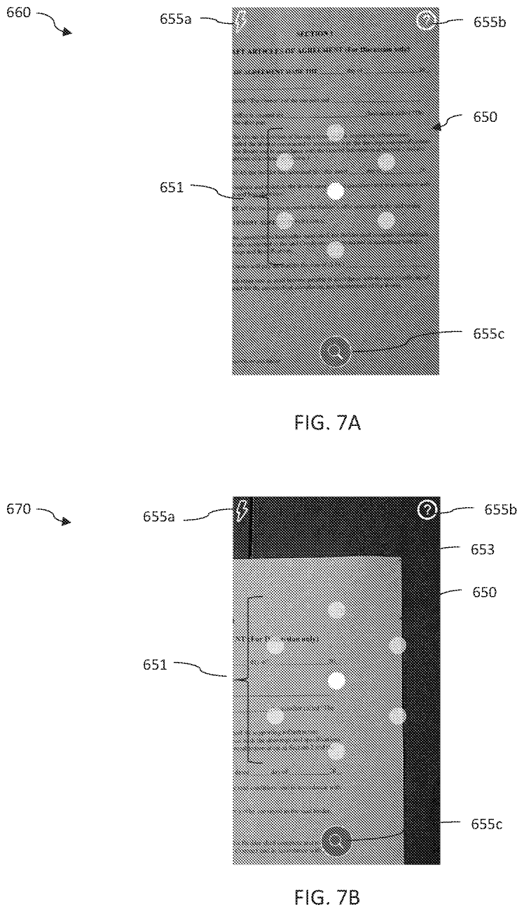

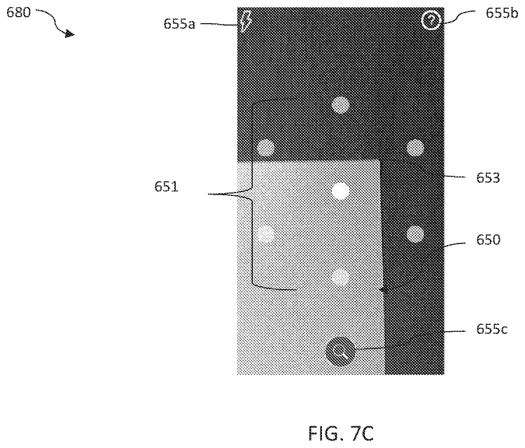

FIGS. 7A-7C illustrate an example series of display images 660-680 including dynamic guiding of a mobile computing device in accordance with aspects of the present disclosure. Mobile computing device 100 of FIG. 1 including imaging hardware 102, for example, can be utilized to capture and display an image, or series of images 660, 670, 680 of printed media 650. The user can capture images 660, 670, 680 of printed media 650 including a detected embedded print pattern (not shown) corresponding to metadata that can provide information on the print source of printed media 650. Upon detecting an embedded print pattern of printed media 650, the user can be notified with display of a message or other visual indicator, for example. Visual, audio, or tactile notifications can be employed to notify a user that an embedded print pattern has been detected within the image of printed media 650. Visual, audio, or tactile notifications can be employed to notify and guide a user to move the mobile computing device to the reading position. Additional indicators 655 can be included as appropriate. For example, a flash indicator 655a can be included to indicate adjustments to lighting of the image. In other examples, search and query indicators 655b, 655c can be provided and displayed to aid the user in the technique.

In one example, a dynamic guide 651 can include an arrangement of translucent dots displayed over the image 660. In one example, dynamic guides 651 can be initiated and visible to the user within display device 122 to indicate the presence of an embedded print pattern. Dynamic guides 651 can be employed as viewable augmented reality overlaid, or projected, onto images 660, 670, 680 of printed media 650 visible to the user within display device 122. Dynamic guides 651 can automatically be resize or repositioned to direct the user to reposition mobile computing device 100 with respect to the print media, as illustrated in FIGS. 7A-7C. For example, dynamic guide 651 can resize from a tighter dot pattern, such as illustrated in FIG. 7A, to enlarged and repositioned patterns of dynamic guide 651, such as illustrated in FIGS. 7B and 7C, to direct the user to move closer and to a corner 653 of printed media 650. Imaging hardware 102 can capture images of printed media 650 within a field of view (FOV) of imaging capture device 120 on an on-going, continuous, or periodic basis as mobile computing device 100 is repositioned with respect to printed media 650. With reference to FIGS. 7B and 7C, the user can be dynamically guided to orient the field of view of the mobile computing device to include a white space, such as corner 653, of printed media 650 that includes the embedded print pattern.

The user can be dynamically guided to position or reposition the imaging hardware as appropriate to facilitate reading of the embedded print pattern. Upon reading the embedded print pattern, mobile computing device 100 can include image analysis functionality for defining metadata within the embedded print content. The processor can facilitate the embedded print pattern analysis to correspond with the image capture process. In one example, the technique prompts a display of the source identification information for the user's viewing and reference. The display of the source identification information can be separate, overlaid, or side-by-side with the image of print media.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A mobile computing device comprising:
imaging hardware to capture an image of a printed media;
memory to store instructions; and
a processor to execute the instructions to:
detect the printed media within a field of view of the imaging hardware;
dynamically guide a user to position the field of view to capture a region of the printed media including an embedded print pattern;
detect the embedded print pattern within the region;
correlate the embedded print pattern with a source identification of the printed media; and
determine the source identification of the printed media.

2. The mobile computing device of claim 1, wherein the processor is to calculate a distance between imaging hardware and the printed media.

3. The mobile computing device of claim 2, wherein the processor is to execute the instructions to dynamically guide the user to an adjusted distance between the imaging hardware and the printed media.

4. The mobile computing device of claim 1, wherein the processor is to execute the instructions to determine a criteria of the embedded print pattern.

5. The mobile computing device of claim 1, wherein the processor is to execute the instructions to determine a guide template to dynamically display on a viewing screen displaying an image of the printed media.

6. The mobile computing device of claim 1, wherein the processor is to execute the instructions to determine detectability criteria of the embedded print pattern.

7. A method of identifying a source identification of a printed media comprising:
detecting a printed media with an imaging hardware of a mobile computing device;
dynamically guiding a user to position a field of view of the imaging hardware to encompass a region of the printed media;
detecting an embedded print pattern within the region of the printed media;
correlating the embedded print pattern with a source identification of the printed media; and
determining the source identification of the printed media.

8. The method of claim 7, comprising:
initiating a detection technique on the mobile computing device to detect the embedded print pattern.

9. The method of claim 7, wherein dynamically guiding the user to position the field of view of the imaging hardware to encompass the region of the printed content includes dynamically repositioning visual indicators on a display of the mobile computing device to direct the user to move the mobile computing device a distance from the printed media.

10. The method of claim 7, wherein dynamically guiding the user to position the field of view of the imaging hardware to encompass the region of the printed content includes dynamically repositioning visual indicators on a display of the mobile computing device to direct the user to move the mobile computing device an orientation relative to the printed media.

11. The method of claim 7, wherein the embedded print pattern is included on a white space of the printed media.

12. The method of claim 7, comprising:
establishing embedded print pattern parameters at a print device.

13. The method of claim 12, comprising:
communicating the established embedded print pattern parameters to the mobile computing device.

14. A non-transitory computer-readable data storage medium storing instructions executable by a processor to:
receive an image of the printed media captured within a field of view of the mobile computing device;
determine whether an embedded print code of the printed media is captured within the field of view of the mobile computing device;
dynamically guide a user from a position to a reading position of the mobile computing device to the embedded print pattern;
receive a second image of the embedded print pattern at the reading position;
read the embedded print pattern;
correlate the read embedded print pattern with a source identification of the printed media; and
identify the source identification of the printed media.

15. The non-transitory computer-readable data storage medium storing instructions executable by a processor of claim 14, comprising:
determine a position of a mobile computing device to a printed media.
